(19) United States
(12) Patent Application Publication
(10) Pub. No.: US 2021/0023890 A1
(43) Pub. Date: Jan. 28, 2021

(54) BAND FOR PROTECTING VEHICLE WHEELS AND TYRES

(71) Applicant: Alexandre Schunn VIANNA, PALHOÇA - SANTA CATA (BR)

(72) Inventor: Alexandre Schunn VIANNA, PALHOÇA - SANTA CATA (BR)

(21) Appl. No.: 17/043,066

(22) PCT Filed: Apr. 10, 2018
(86) PCT No.: PCT/BR2018/050096

§ 371 Date: Sep. 29, 2020

(51) Int. Cl. B60C 17/04; B60B 19/00

(52) U.S. Cl. CPC B60C 17/04; B60B 19/00

(57) ABSTRACT

Band for protecting vehicle wheels and tires, is a protective system for wheels with variable adjustment (setup), which allows a single product to be used in different wheel sizes. Characterized by two semicircular rubber segments of “I” profile in half moon shape, with 50% wider base and 30% wider top, both in relation to the central part of the product; each part (half moon shape) has at its ends a fitting system called “Parrot Spout” simple at one end and double at the other, to allow the overlap of the parts, being attached by a set of ratchets that pull the steel cables or high resistance tape to attach the ends of the parts; it has a passenger compartment (spacing) to allocate the valve or pressure sensor.

### FIELD OF INVENTION

This Patent of Invention relates to a protective system for wheels with variable adjustment (setup), which is in the interior of the tire, allowing the vehicle to travel normally (and in emergency situations), facing a flat tire or even without tire, comprising two semicircular rubber segments of semicircular “I” profile.

### TECHNICAL DIFFERENCE

The referred to system allows a single product to be installed on wheels of different dimensions (radius/circumference).

The product comprising rubber has at its ends a fitting system called “Parrot Spout”, where the end of one part is allocated at the end of the other part, keeping the internal and external circumference of the product 100% in contact with the tire and the wheel, providing 100% of its functionality, even when the product is used in different measures (Radius/Circumference),

The ends are attached by a set of ratchets (2) that pull steel cables or any other material of high resistance, adapting the radius of the product (flexible product) to the radius of the wheel to be used.

Considering that the elastomer has a certain flexibility, the base of the product is increased by an average of 50% (or more) wider than its body, to provide greater stability and adhesion of the product to the wheel, minimizing the lateral flexibility of the product during its use.

The profile also has in its upper part a measure 30% larger than its body, in order to have a greater contact area between the product and the lower base of the tire, reducing the pressure per square centimeter (cm²) of the tire over the product, providing an increase in the autonomy of its use, especially when the vehicle is without a tire.

The product has a passenger compartment (spacing) to allocate the valve or pressure sensor, so as the wheel is not submitted to air supply blockage by the product.

The BAND FOR PROTECTING VEHICLE WHEELS AND TIRES provides improvements, such as:

### 1^{st} Improvement: “PARROT SPOUT FITTING”

The product comprising rubber has at its ends a fitting system called “Parrot Spout”, where the end of one part is allocated at the end of the other part, keeping the internal and external circumference of the product 100% in contact with the tire and the wheel, allowing the product to be used in different wheel measures (Radius/Circumference) without losing its efficacy.

### 2^{nd} Improvement: FLEXIBLE STRUCTURE/MASS

The new product comprising an elastomer of lower hardness, so that the locking system, ratchets and steel cables are able to bend and adapt the elastomer product, so as it fits in any radius.

The new hardness of the elastomer compound used in the product is between 70 shores (typeA)/80 shores (typeA), much more flexible than the previous ones that worked between 85 shores (typeA)/90 shores (typeA).

### 3^{rd} Improvement: PROFILE (Base/Top):

Considering that the elastomer has a certain flexibility, we increased the base of the product by an average of 50% (or more) wider than its body, to provide greater stability and adhesion of the product to the wheel, minimizing the lateral flexibility of the product during its use.

The profile also has in its upper part a measure 30% larger than its body, in order to have a greater contact area between the product and the lower base of the tire, reducing the pressure per square centimeter (cm²) of the tire over the product, providing an increase in the autonomy of its use, especially when the vehicle is without a tire.

### 4^{th} Improvement: PASSENGER COMPARTMENT (Valve/Pressure Sensor):

The product has a passenger compartment (spacing) to allocate the valve or pressure sensor, so as the wheel is not submitted to air supply blockage by the product.

The BAND FOR PROTECTING VEHICLE WHEELS AND TIRES provides the following benefits:

In passenger vehicles' line: the same product can be used in the 16, 17, 18, 19, 20 inches rims.

In Bus and Truck line: the same product can be used in the 17.5, 19.5, 20, 22.5, 24.5 inches rims.

For the MANUFACTURER: once can use 01 production line with 01 mold and manufacture 01 product that can be used on 4 or 5 wheels with different measures (radii/circumferences).
Previously, the manufacturer would need to have 01 production line and 01 mold to produce 01 specific product for each wheel.

For the RETAILER: one can purchase and store only 01 product, which can be used on 4 or 5 wheels with different measures (radii/circumferences), saving up to 80% the amount invested in stock.
Previously, the retailer would need to have 01 specific product for each wheel, significantly costing one's investment in stock and still taking the risk of stocking products with “low trade” measures for too long, entailing losses in the cash flow.

For the USER: one can purchase 01 product to use currently in their vehicle and that later, if the user changes the vehicle with wheels of different sizes, this person can reuse the previously purchased product.
Previously the user would purchase 01 product for each wheel and if later changed vehicles with wheels of different dimensions (radius/circumference), it was necessary to purchase a specific product for the new wheel measurement.

### DESCRIPTION OF DRAWINGS

In order to obtain a total and complete visualization of how the BAND FOR PROTECTING VEHICLE WHEELS AND TIRES, herein concerned and object of the present Patent of Invention, references shall be made to the drawing attached herein, where:

FIG. 1 shows the front face (ratchet side);

FIG. 2 shows the rear face;

FIG. 3 shows the upper face;

FIG. 4 shows the lower face;

FIG. 5 shows the Parrot Spout Positive End;

FIG. 6 shows the Parrot Spout Negative End;

FIG. 7 shows the “Passenger compartment—air flow” (Valve or Pressure Sensor);

FIGS. 8, 9 and 10 show the product assembled at different angles;

FIG. 11 shows the 17 inches Rim Wheel—Passenger Vehicle;

FIG. 12 shows the 17.5 inches Rim Heavy Duty Wheel—Bus or Trucks, (100% covering of the external perimeter of the product and 100% contact of the product with the wheel);

FIG. 13 shows the Adjustment of “Parrot Spout” in “Measurement A” (smaller size) position;

FIG. 14 shows the 18 inches Rim Wheel—Passenger Vehicle;

FIG. 15 shows the 19.5 inches Rim Heavy Duty Wheel—Bus or Trucks, (100% covering of the external perimeter of the product and 100% contact of the product with the wheel);

FIG. 16 shows the Adjustment of “Parrot Spout” in “Measurement B” (Intermediate Small) position;

FIG. 17 shows the 19 inches Rim Wheel—Passenger Vehicle;

FIG. 18 shows the 22.5 inches Rim Heavy Duty Wheel—Bus or Trucks, (100% covering of the external perimeter of the product and 100% contact of the product with the wheel);

FIG. 19 shows the Adjustment of “Parrot Spout” in “Measure C” (Intermediate Large) position;

FIG. 20 shows the 20 inches Rim Wheel—Passenger Vehicle;

FIG. 21 shows the 24.5 inches Rim Heavy Duty Wheel—Bus or Trucks;

FIG. 22 shows the Adjustment of “Parrot Spout” in “Measurement D” (larger size) position;

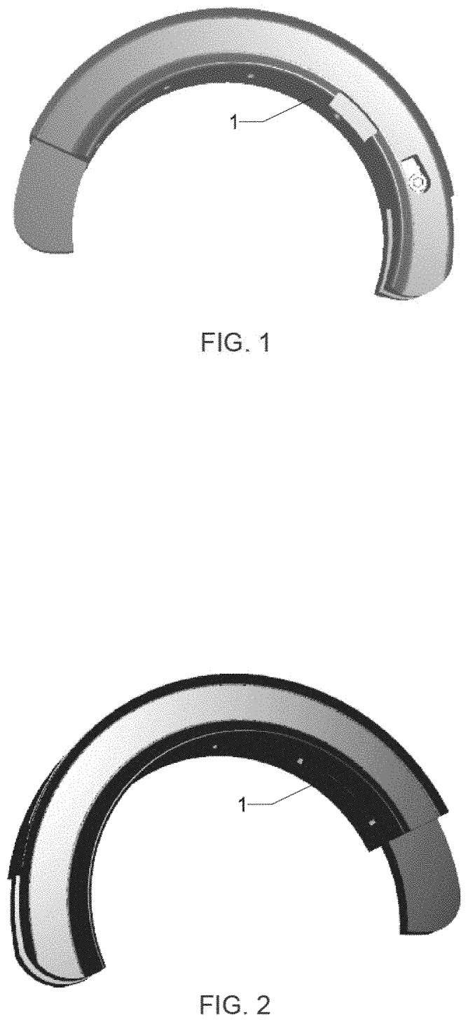

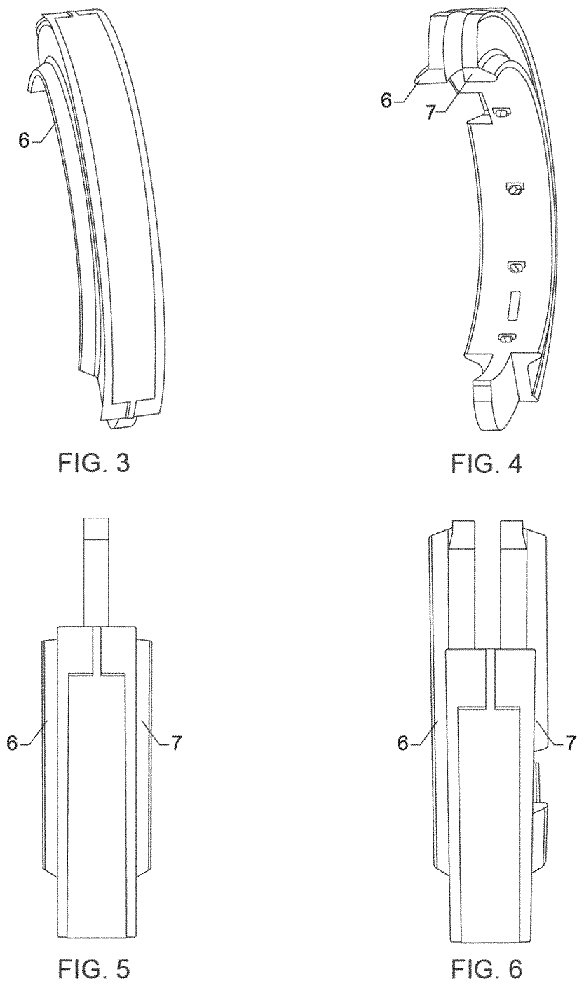

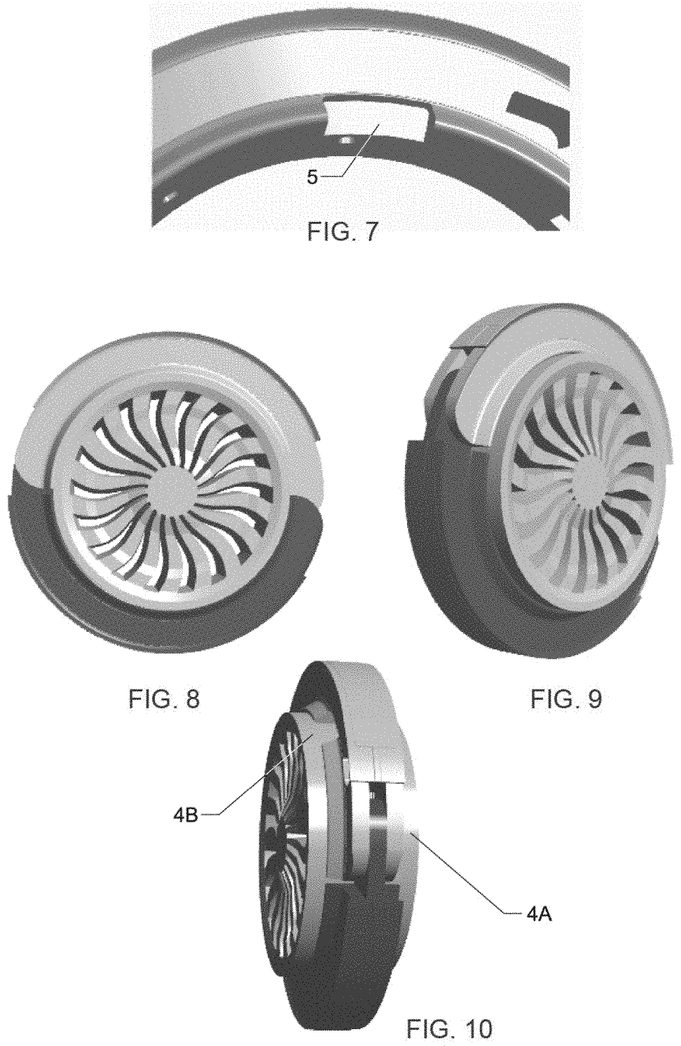

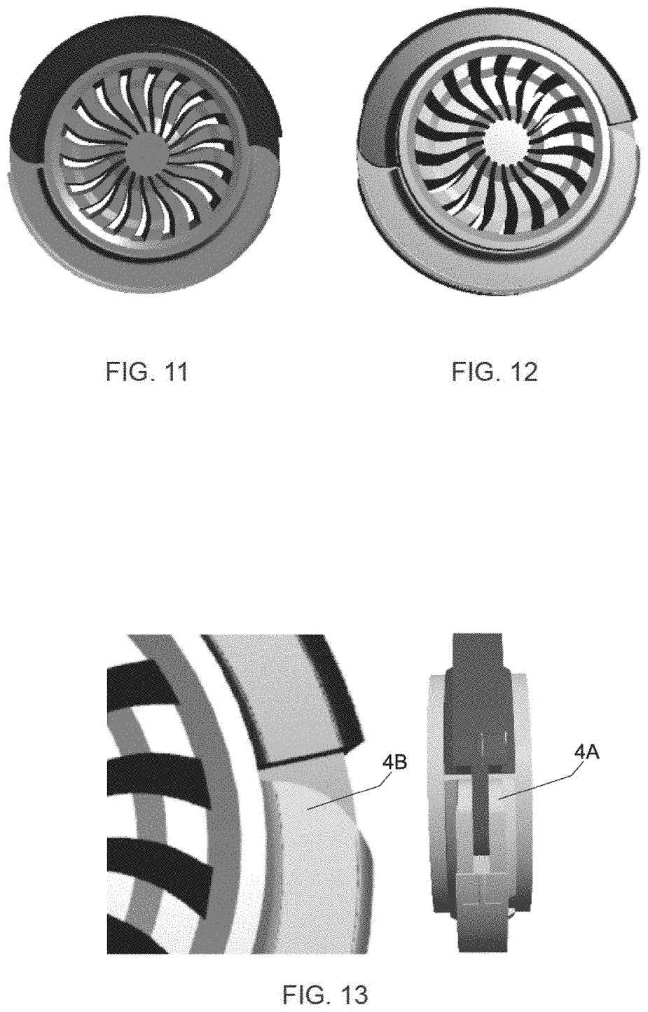

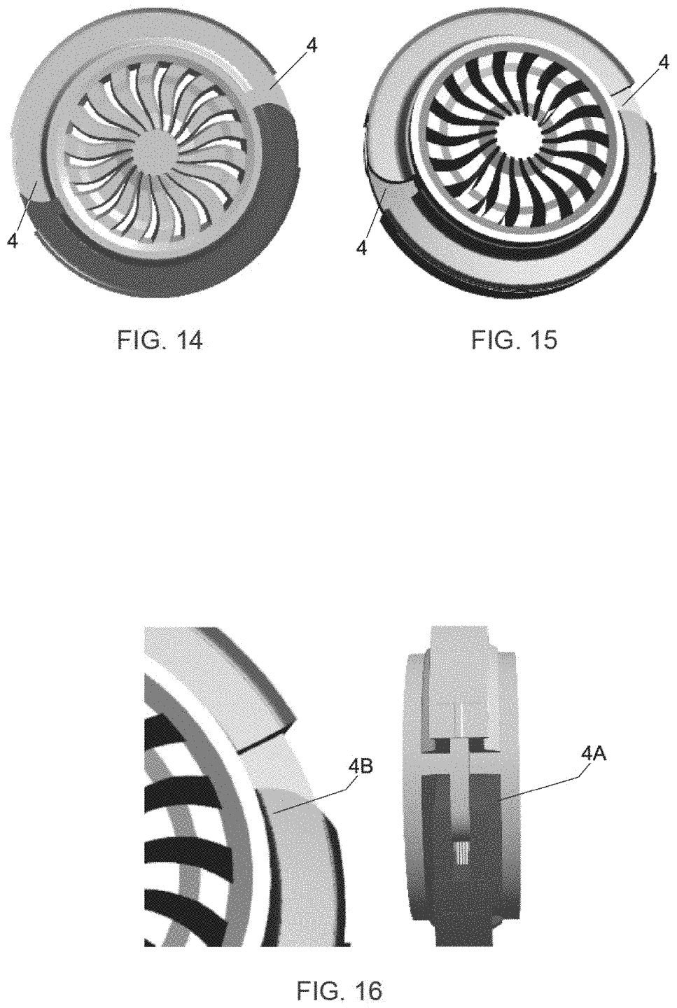

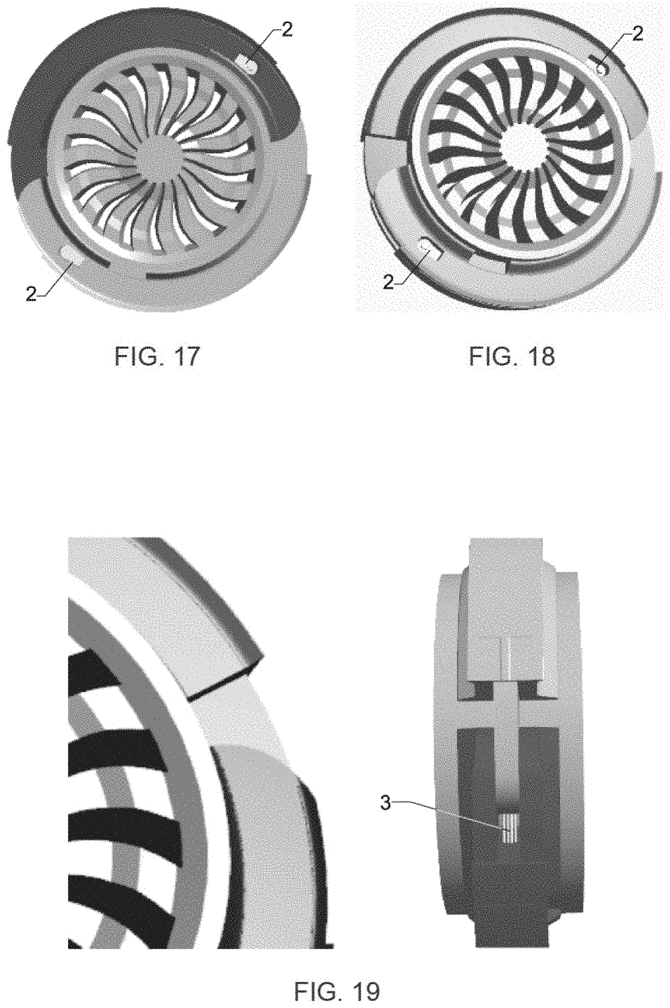

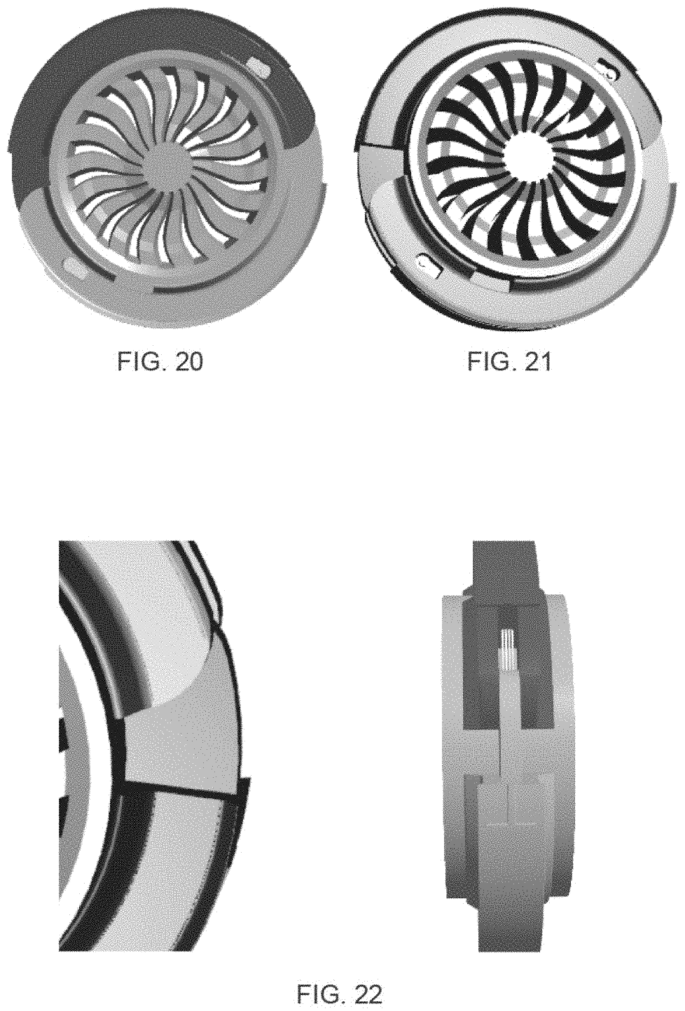

“BAND FOR PROTECTING VEHICLE WHEELS AND TIRES”, pursuant to the drawings attached hereto, characterized by two semicircular rubber segments of “I” profile (1) in half moon shape, with a base 50% wider than the central part of the product (6 and 7), with the top 30% wider than the central part of the product; each part (half moon shape) has at its ends a fitting system called “Parrot Spout” (4), simple (4A) at one end and double (4B) at the other, to allow the overlap of the parts, being attached by a set of ratchets (2) that pull the steel cables or high resistance tape (3) to attach the ends of the parts; it has a passenger compartment (spacing) (5) to allocate the valve or pressure sensor so as the wheel is not submitted to air supply blockage by the product comprising elastomer, allowing the flexibility and curvature of the product to fit any wheel (different radii/circumferences).

### CONCLUSION

It can be seen from everything that has been described and shown, that it is a BAND FOR PROTECTING VEHICLE WHEELS AND TIRES, of great importance to the intended purpose, and must fill an important gap in the market, fully satisfying the proposed objectives and fulfilling in a practical and efficient manner the functions intended, providing a series of advantages inherent to their applicability, having their own innovative characteristics, and endowed with essential requirements of innovation and inventive activity, required to deserve the Patent of Invention protection.

1) Band for protecting vehicle wheels and tires, characterized by two semicircular rubber segments of “I” profile (1) in half moon shape, with a base 50% wider than the central part of the product (6 and 7), with the top 30% wider than the central part of the product; each part (half moon shape) has at its ends a fitting system called “Parrot Spout” (4), simple (4A) at one end and double (4B) at the other, to allow the overlap of the parts, being attached by a set of ratchets (2) that pull the steel cables or high resistance tape (3) to attach the ends of the parts; it has a passenger compartment (spacing) (5) to allocate the valve or pressure sensor.

2) Band for protecting vehicle wheels and tires, characterized by allowing the flexibility and curvature of the product to fit any wheel (different radii/circumferences).

3) Band for protecting vehicle wheels and tires, characterized by keeping the internal and external circumference of the product 100% in contact with the tire and the wheel.
